(19) United States
(12) Patent Application Publication
(10) Pub. No.: US 2002/0153724 A1
(43) Pub. Date: Oct. 24, 2002

(54) Axial force blocking pipe joint

(76) Inventor: Ching Zeng Yeh, Kaohsiung (TW)

Correspondence Address: Keith Kline, PRO-TECHTOR INTERNATIONAL, 20775 Norada Court, Saratoga, CA, 95070-3018, US

(21) Appl. No.: 09/839,983

(22) Filed: Apr. 20, 2001

(51) Int. Cl. F16L 37/00

(52) U.S. Cl. 285/305

(57) ABSTRACT

An axial force blocking pipe joint, comprising an insertion part, a sleeve and several sealing rings. The insertion part is attached to a second pipe. The sleeve is attached to a first pipe, taking in the insertion tube. The sealing rings are mounted on the insertion tube, ensuring a tight connection thereof with the sleeve. The main characteristic of the present invention is that the sleeve has a far end part that forms an axial positioning part, which is located around the second pipe, leaving a gap. The axial positioning part has a blocking element at a far end which extends inwards and a plurality of axial positioning blocks. The plurality of axial positioning blocks are disposed in the gap and fit between a step at a remote end of the insertion tube and the blocking element, thus blocking the insertion tube from separating from the sleeve.

### BACKGROUND OF THE INVENTION

1. Field of the Invention

The present invention relates to an axial force blocking pipe joint, particularly to an axial force blocking pipe joint for large-sized water supply pipes or gas pipes.

2. Description of Related Art

Water supply pipes or gas pipes of large sizes have ends which are mostly connected by welding or have flanges that are joined. For establishing connections of pipes using these methods, however, the pipes have to be aligned before manual joining by welding or screwing can proceed. This method is not only cumbersome, but there is also no way of immediately testing the connection for leaks. Only after a pipe assembly has been completed, leak testing can be performed by applying pressure and checking for leaks. Since at this time a complete pipe assembly has been formed, locating and repairing a leaky pipe joint is difficult.

Furthermore, a conventional connection by welding or screwing together flanges is rigid, without flexibility. Therefore, after burying of pipe assembly in the ground, if the ground is moved or the pipes are buckled, the pipe joints crack, and leaks result. Thus conventional pipe joints easily develop leaks.

For these reasons, making conventional pipe joints is not only difficult and time-consuming, but conventional pipe joints become leaky due to pressure when the ground is moved or the pipes are buckled. So there is an obvious need for improvement of conventional pipe joints.

### SUMMARY OF THE INVENTION

It is the main object of the present invention to provide an axial force blocking pipe joint which is easily and quickly assembled.

Another object of the present invention is to provide an axial force blocking pipe joint which is flexible, so as to prevent leaks from developing.

A further object of the present invention is to provide an axial force blocking pipe joint which does not loosen.

The present invention can be more fully understood by reference to the following description and accompanying drawings.

### BRIEF DESCRIPTION OF THE DRAWINGS

FIG. 1 is a sectional side view of the axial force blocking pipe joint of the present invention when disassembled.

FIG. 2 is a sectional side view of the axial force blocking pipe joint of the present invention when assembled.

FIG. 3 is a cross-sectional side view of the axial force blocking pipe joint of the present invention.

### DETAILED DESCRIPTION OF THE PREFERRED EMBODIMENT

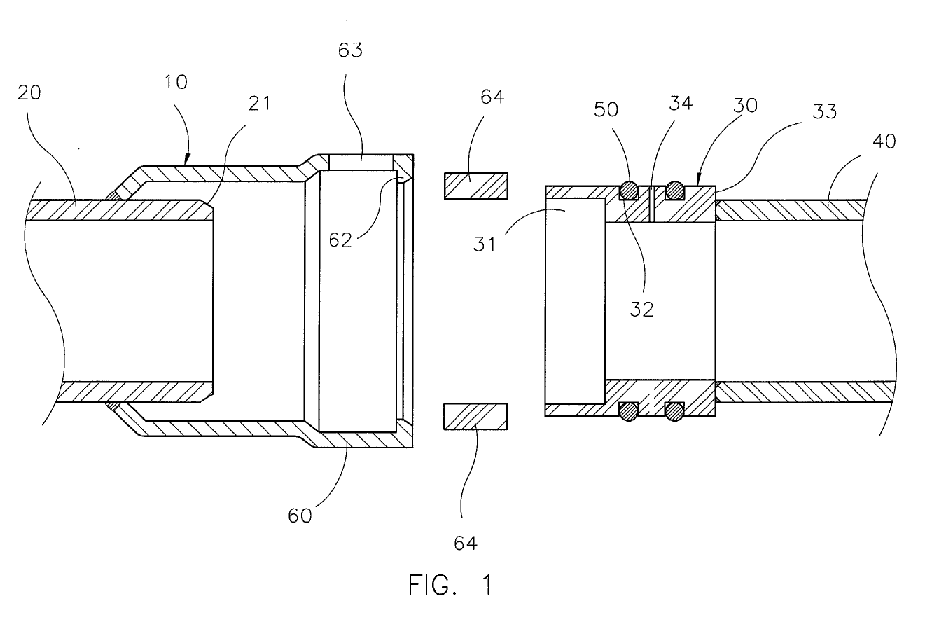

As shown in FIG. 1, the axial force blocking pipe joint of the present invention mainly comprises: a sleeve 10 on a rear end of a first pipe 20; and an insertion tube 30, attached to a second pipe 40 at a front end thereof which is located next to the first pipe 20. The insertion tube 30 is inserted into the sleeve 10 for connecting the first pipe 20 and the second pipe 40.

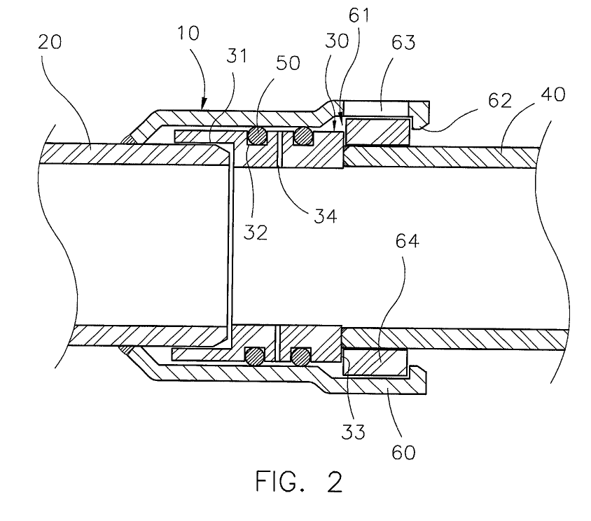

Referring to FIGS. 1 and 2, the insertion tube 30 is welded to the front end of the second pipe 40, having an outer diameter that is slightly larger than the outer diameter of the second pipe 40, so that a step 33 is formed where the insertion part 20 and the second pipe 40 are connected. The insertion tube 30 has a front end with an accommodating opening 31. The accommodating opening 31 has an inner diameter that is slightly larger than the outer diameter of the first pipe 20, being able to take in the first pipe 20 at the rear end thereof. The rear end of the first pipe 20 has a beveled outer edge 21 for easy inserting thereof into the accommodating opening 31.

The insertion tube 30 in a middle part thereof has at least two peripheral grooves 32. Sealing rings 50 are laid into the peripheral grooves 32. As shown in FIG. 2, the sleeve 10 has an outer diameter that is slightly larger than the outer diameter of the insertion tube 30, allowing to slip the insertion tube 30 into the sleeve 10. The sleeve 10 is shaped like a tube, having a front end which is welded to the first pipe 20 from outside and a rear end that extends beyond the rear end of the first pipe 20, so that the sleeve 10 takes in the insertion tube 30 completely. Having inserted the insertion tube 30 into the sleeve 10, the sealing rings 50 ensure a tight connection between the outer side of the insertion tube 30 and the inner side of the sleeve 10, preventing liquid in the first and second pipes 20, 40 from leaking out through the open space between the insertion tube 30 and the sleeve 10.

The main characteristic of the present invention is an extension at the rear end of the sleeve 10, forming an axial positioning part 60. As shown in FIG. 2, a ring-shaped gap 61 is left between the axial positioning part 60 and the second pipe 40. The axial positioning part 60 has a rear end that is formed as a blocking element 62. An insertion opening 63 is laterally cut into the axial positioning part 60. Several axial positioning blocks 64 are inserted through the insertion opening 63, filling the gap 61.

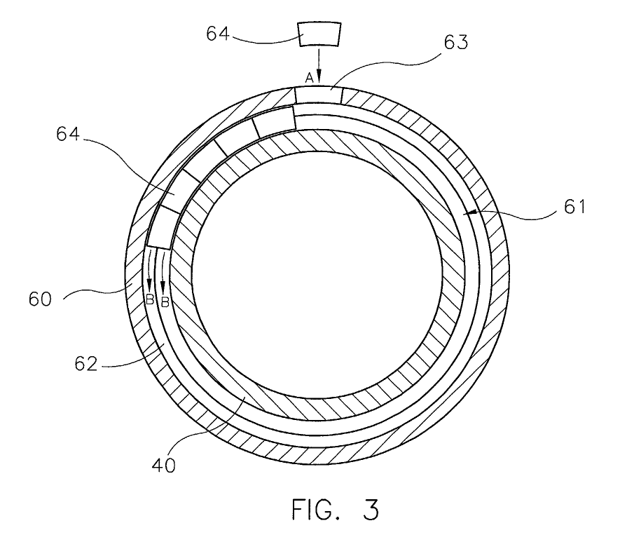

Referring to FIG. 3, the axial positioning blocks 64 are slightly thinner than the width of the gap 61 and slightly narrower than the insertion opening 63 and are curved like the gap 61 between the axial positioning part 60 and the second pipe 40. Therefore the several axial positioning blocks 64 are readily inserted through the insertion opening 63 (as indicated by the arrow A) and move along the gap 61. Thus a worker is able to insert the several axial positioning blocks 64 one by one into the gap 61 (as indicated by the arrow B), filling the gap 61.

Referring again to FIG. 2, the axial positioning blocks 64 are slightly shorter than the space between the step 33 at the rear end of the insertion tube 30 and the blocking element 62. Thus the axial positioning blocks 64, after having been inserted into the gap 61, fit in between the step 33 and the blocking element 62, blocking the insertion tube 30 and the sleeve 10 from performing an axial movement against each other. This achieves the object of blocking against axial forces.

For putting the insertion tube 30, the sleeve 10 and the first and second pipes 20, 40 of the present invention into each other, suitable space is assigned, then the sealing rings 50 are mounted to seal the open space between the insertion tube 30 and the sleeve 10, so as to prevent liquid from leaking out. Therefore, when the first and second pipes 20, 40 are slanted against each other by a small angle, the insertion tube 30 and the sleeve 10 are still tightly connected, and no leak will develop.

Furthermore, a testing hole 34 is readily provided between the two peripheral grooves 32. This allows, after the sleeve 10 has taken in the insertion tube 30, to connect a testing tube (not shown) and apply water pressure to test whether the insertion tube 30 and the sleeve 10 are sealed against each other. Any improper function is then discovered early and can be fixed immediately.

The axial force blocking pipe joint of the present invention has the following main advantages:

1. For connecting pipes, it is only required to put the insertion tube 30 into the sleeve 10 and, after that, to insert the axial positioning blocks 64 into the gap 61 to complete assembling of the first and second pipes 20, 40. Thus assembly is performed conveniently and quickly. At the time of assembling, the insertion tube 30 and the sleeve 10 fit together automatically without misaligning, so that rates of failure due to improper working are kept low.

2. The axial positioning blocks 64 block relative axial movements, ensuring that the insertion tube 30 and the sleeve 10 will not be separated from each other by axial forces. Furthermore, since the sleeve 10 surrounds the insertion tube 30, limited bending is accommodated. When the first and second pipes 20, 40 undergo non-uniform outer pressure, no leak between the insertion tube 30 and the sleeve 10 will develop due to buckling.

3. Small bending, stretching and contracting movements between the sleeve 10 and the insertion tube 30 are accommodated. Therefore, movement of the ground will not result in buckling and leaks.

While the invention has been described with reference to a preferred embodiment thereof, it is to be understood that modifications or variations may be easily made without departing from the spirit of this invention which is defined by the appended claims.

1. An axial force blocking pipe joint, comprising:
an insertion part, attached to a second pipe at an end thereof;
a sleeve, attached to a first pipe at an end thereof that is next to said second pipe, taking in said insertion tube and having a far end part that forms an axial positioning part, which is located around said second pipe, leaving a gap, and further comprises
a blocking element at a far end, extending inwards therefrom towards a location beyond a remote end of said insertion tube,
a plurality of axial positioning blocks, disposed in said gap and fitting between a step at said remote end of said insertion tube and said blocking element, thus blocking any axial movement of said insertion tube towards said blocking element, so that said first and second pipes will stay connected, and
an insertion opening for inserting said plurality of axial positioning blocks into said gap; and
several sealing rings, mounted on an outer side of said insertion tube, ensuring a tight connection thereof with an inner side of said sleeve;
wherein said plurality of axial positioning blocks provide positioning of said sleeve and said insertion tube relative to each other, preventing separation thereof upon axial forces and maintaining a sealed connection.

2. An axial force blocking pipe joint according to claim 1, wherein said insertion tube has a diameter which is larger than diameters of said first and second pipes and has a near end with an accommodating opening for taking in said end of said first pipe.

3. An axial force blocking pipe joint according to claim 1, wherein said insertion tube has a testing hole which is located between said several sealing rings.
